(19) United States
(12) Patent Application Publication
(10) Pub. No.: US 2017/0260768 A1
(43) Pub. Date: Sep. 14, 2017

(54) HYBRID WIND POWER TOWER HAVING STEEL TOWER AND DSCT TOWER COMBINED

(71) Applicant: Korea Institute of Ocean Science & Technology, Gyeonggi-do (KR)

(72) Inventors: Taek Hee Han, Seoul (KR); Jin-Hak Yi, Gyeonggi-do (KR); Young Hyun Park, Gyeonngi-do (KR); Jin Soon Park, Gyeonggi-do (KR); Hyun Hee Ju, Gyeonngi-do (KR)

(21) Appl. No.: 15/155,829

(22) Filed: May 16, 2016

(30) Foreign Application Priority Data
Mar. 14, 2016 (KR) 2016-0030143

(51) Int. Cl. E04H 12/12; E04H 12/34; F03D 13/20; E02D 27/42

(52) U.S. Cl. CPC E04H 12/12; E02D 27/425; E04H 12/342; F03D 13/20

(57) ABSTRACT

The present invention relates to a hybrid wind power tower including: a DSCT structure part having an inner steel tube and an outer steel tube that concentrically stand on a foundation, wherein a space between the inner steel tube and the outer steel tube is filled with concrete; and a steel structure part provided on the DSCT structure part. The hybrid wind power tower having a steel tower and a DSCT tower combined is configured in such a manner that a plastic hinge that is required to bear huge loads is provided with the DSCT tower structure having high strength, and the economical steel tower structure is provided on the plastic hinge, thereby maximizing safety and cost efficiency of a wind power tower.

### CROSS REFERENCE TO RELATED APPLICATION

The present application claims priority to Korean Patent Application No. 10-2016-0030143, filed Mar. 14, 2016, the entire contents of which is incorporated herein for all purposes by this reference.

### BACKGROUND OF THE INVENTION

Field of the Invention

The present invention relates generally to a hybrid wind power tower having a steel tower and a DSCT tower combined. More particularly, the present invention relates to a hybrid wind power tower, in which the hybrid tower includes a double-skinned composite tubular (DSCT) structure at a lower part thereof near a foundation, the DSCT structure having high safety due to high strength, and includes an economical steel structure provided on the lower part, thereby maximizing a moment resisting capacity and increasing cost efficiency.

Description of the Related Art

Generally, a megawatt-class (MW) wind power tower is 80 to 100 meters in average height. The wind power tower is required to be constructed not to be deformed by a heavy weight of a turbine, and by wind loads applied to the wind power tower when thrust and wind produced during rotation of the turbine hit the wind power tower.

Currently, a wind power tower is generally made of steel materials, and the height of the wind power tower is increasing due to enlargement of wind power turbines and blades. Accordingly, a slenderness ratio of the wind power tower is increased. The increased slenderness ratio decreases buckling stability of the wind power tower made of the steel materials. In addition, the wind power tower is inevitably increased in diameter at a lower part thereof, and thus the wind loads applied to the wind power tower are increased. That is, as height of a wind power tower increases, a shape of the wind power tower is required to be differently designed, compared to a shape of a wind power tower of the prior art.

To keep the buckling stability and the wind loads of the wind power tower at an appropriate level, a high performance composite-structure wind power tower has been researched and developed.

As a high performance composite-structure wind power tower, an internally confined hollow reinforced concrete (ICH RC) wind power tower and a double-skinned composite tubular (DSCT) wind power tower have been researched and developed.

Compared to the wind power tower of the prior art, which is made of steel materials, the ICH RC wind power tower or the DSCT wind power tower can support larger loads though having a smaller cross-section, and does not suffer from sudden decrease of the buckling stability due to the increased slenderness ratio, thereby eliminating the problem of buckling failure.

Accordingly, compared to the wind power tower of the prior art, which is made of the steel materials, the ICH RC wind power tower or the DSCT wind power tower can support a heavier turbine and be applied to constructing a taller wind power tower.

However, compared to the wind power tower of the prior art, which is made of the steel materials, the ICH RC wind power tower or the DSCT wind power tower is expensive to manufacture.

Meanwhile, a wind power tower has a cantilever structure, in which loads are concentrated on a plastic hinge of a lower part thereof that is in contact with a foundation. A moment resisting capacity of the plastic hinge on which the loads are concentrated is the most important criterion in evaluating the performance of the wind power tower.

The foregoing is intended merely to aid in the understanding of the background of the present invention, and is not intended to mean that the present invention falls within the purview of the related art that is already known to those skilled in the art.

### DOCUMENTS OF RELATED ART

(Patent Document 1) Korean Utility Model Application Publication No. 20-2015-0004366 (published on Dec. 7, 2015)

### SUMMARY OF THE INVENTION

Accordingly, the present invention has been made keeping in mind the above problems occurring in the related art, and the present invention is intended to propose a hybrid wind power tower having a steel tower and a DSCT tower combined, in which the hybrid tower includes a double-skinned composite tubular (DSCT) structure at a lower part thereof near a foundation, the DSCT structure having high safety due to high strength, and includes an economical steel structure provided on the lower part, thereby maximizing a moment resisting capacity and increasing cost efficiency.

In order to achieve the above object, according to one aspect of the present invention, there is provided a hybrid wind power tower including: a double-skinned composite tubular (DSCT) structure part having an inner steel tube and an outer steel tube that concentrically stand on a foundation, wherein a space between the inner steel tube and the outer steel tube is filled with concrete; and a steel structure part provided on the DSCT structure part.

In addition, the steel structure part may extend from the inner steel tube or the outer steel tube, an upper surface of the concrete may be leveled so as to be perpendicular to a central axis of a longitudinal direction of the DSCT structure part, and a combination-maintaining member may be provided on the upper surface of the concrete, the combination-maintaining member increasing a force of combining the steel structure part with the DSCT structure part.

Furthermore, the combination-maintaining member may include: a disc-shaped steel plate fixed on the upper surface of the concrete; and a reinforcing member protruding along a width direction of the steel plate so as to be combined with the steel structure part, wherein the reinforcing member may include a plurality of reinforcing members provided on the steel plate at predetermined intervals.

Additionally, an upper surface of the concrete may be leveled so as to be perpendicular to a central axis of a longitudinal direction of the DSCT structure part, a disc plate may be provided to a lower end part of the steel structure part such that the disc plate sits on the upper surface of the concrete, wherein the disc plate sitting on the upper surface of the concrete may be welded to the inner steel tube and the outer steel tube, and a plurality of bolts passing through the disc plate may be fastened to the concrete.

In addition, an inner diameter or an outer diameter of the disc plate may be the same as a diameter of the lower end part of the steel structure part, or the inner diameter of the disc plate may be smaller than the diameter of the lower end part of the steel structure part, and the outer diameter of the disc plate may be larger than the diameter of the lower end part of the steel structure part.

Furthermore, the plurality of reinforcing members may be provided by protruding from an upper surface of the disc plate such that one surface of each of the reinforcing members is combined with the steel structure part.

Additionally, the inner diameter of the disc plate may be smaller than the diameter of the lower end part of the steel structure part, and the outer diameter of the disc plate may be larger than the diameter of the lower end part of the steel structure part, and a plurality of through holes may be provided in an inner sector or an outer sector of the disc plate that is divided based on the lower end part of the steel structure part, the bolts being fastened to the concrete after passing through the plurality of through holes.

In addition, the steel structure part may extend from the inner steel tube, and an outer expansion tube may be provided on an end part of the outer steel tube, a diameter of the outer expansion tube decreasing in an upward direction such that the outer expansion tube comes into contact with the steel structure part.

Furthermore, the steel structure part may extend from the outer steel tube, and an inner expansion tube may be provided on an end part of the inner steel tube, a diameter of the inner expansion tube increasing in an upward direction such that the inner expansion tube comes into contact with the steel structure part.

Additionally, the inner expansion tube may be provided on an end part of the inner steel tube, the diameter of the inner expansion tube increasing in the upward direction, the outer expansion tube may be provided on an end part of the outer steel tube, the diameter of the outer expansion tube decreasing in the upward direction, and the lower end part of the steel structure part may be combined with end parts of the inner expansion tube and the outer expansion tube, the inner expansion tube and the outer expansion tube being in contact with each other at the end parts thereof.

In addition, the inner steel tube may have a circular cross-section in a width direction thereof, the outer steel tube may have a polygonal cross-section such as a rectangular, a hexagonal or an octagonal cross-section, or have a circular cross-section in a width direction thereof, and the steel structure part may have a polygonal cross-section such as a rectangular, a hexagonal or an octagonal cross-section, or have a circular cross-section in a width direction thereof. According to the hybrid wind power tower of the present invention having the above-mentioned configuration, a plastic hinge that is required to bear huge loads is configured to have the DSCT tower structure having high strength, and an economical steel tower structure is provided on the plastic hinge, which maximizes safety and cost efficiency of a wind power tower.

In addition, the hybrid wind power tower can be easily applied to piers or columns of a building.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a side sectional view of a hybrid wind power tower according to a first embodiment of the present invention;

FIG. 2 is a longitudinal cross-sectional view of an important part of the hybrid wind power tower according to the first embodiment of the present invention;

FIG. 3 is a cross-sectional perspective view of the important part of the hybrid wind power tower according to the first embodiment of the present invention;

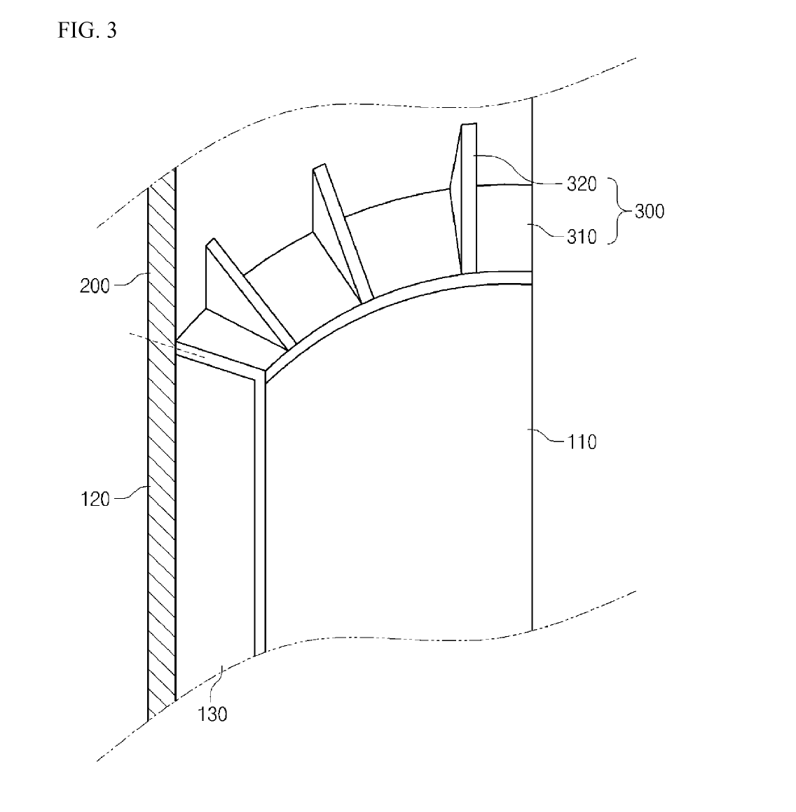

FIG. 4 is a longitudinal cross-sectional view of an important part of a hybrid wind power tower according to a second embodiment of the present invention;

FIG. 5 is a longitudinal cross-sectional view of an important part of a hybrid wind power tower according to a third embodiment of the present invention;

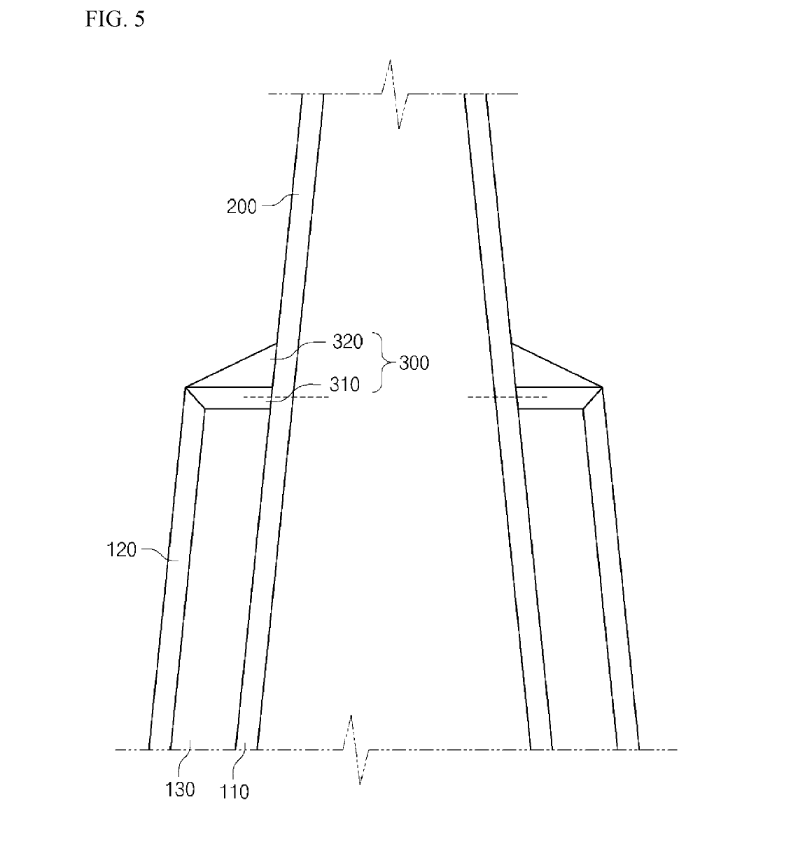

FIG. 6 is a longitudinal cross-sectional view of an important part of a hybrid wind power tower according to a fourth embodiment of the present invention;

FIG. 7 is a longitudinal cross-sectional view of an important part of a hybrid wind power tower according to a fifth embodiment of the present invention;

FIG. 8 is a longitudinal cross-sectional view of an important part of a hybrid wind power tower according to a sixth embodiment of the present invention;

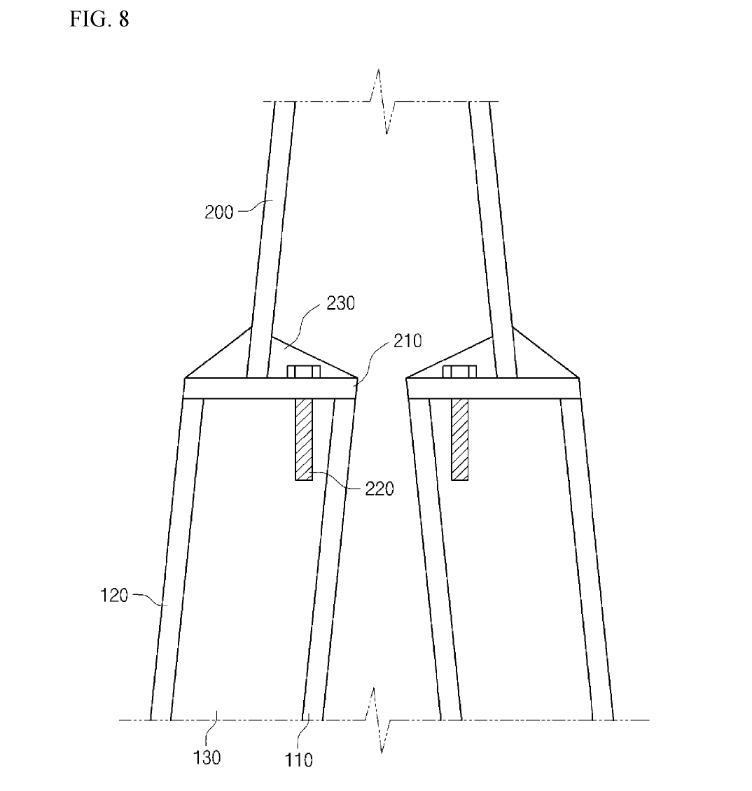

FIG. 9 is a longitudinal cross-sectional view of an important part of a hybrid wind power tower according to a seventh embodiment of the present invention;

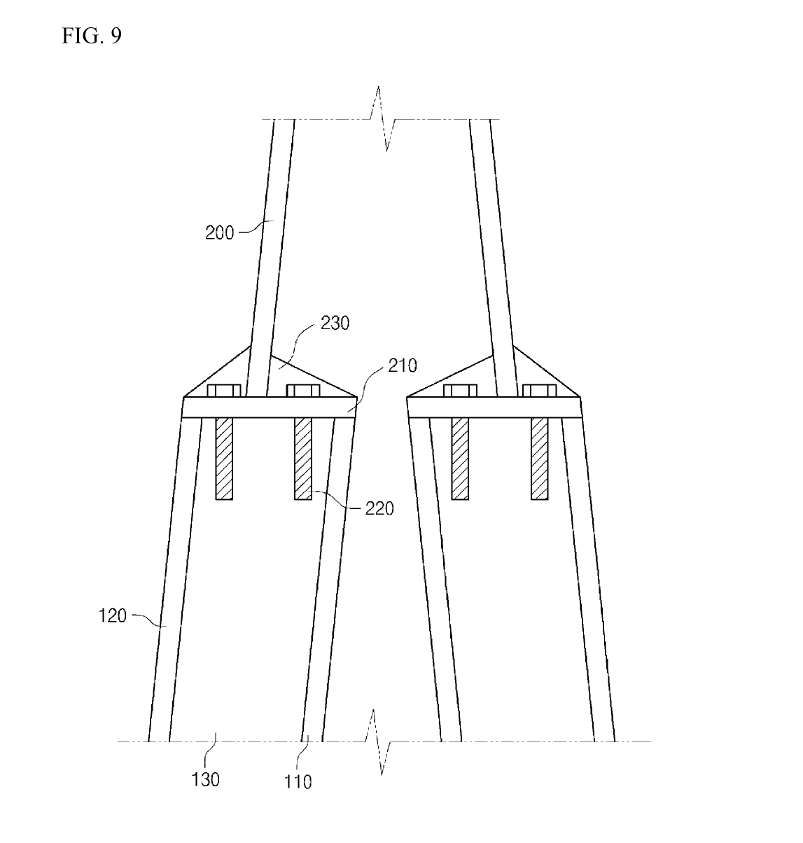

FIG. 10 is a longitudinal cross-sectional view of an important part of a hybrid wind power tower according to an eighth embodiment of the present invention;

FIG. 11 is a longitudinal cross-sectional view of an important part of a hybrid wind power tower according to a ninth embodiment of the present invention;

FIG. 12 is a longitudinal cross-sectional view of an important part of a hybrid wind power tower according to a tenth embodiment of the present invention;

FIG. 13 is a cross-sectional view of a width direction of a DSCT structure part of the hybrid wind power tower according to the first embodiment of the present invention; and

FIG. 14 is a cross-sectional view of a width direction of a steel structure part of the hybrid wind power tower according to the first embodiment of the present invention.

### DETAILED DESCRIPTION OF THE INVENTION

Hereinbelow, exemplary embodiments of the present invention will be described in detail with reference to the accompanying drawings. Throughout the drawings, the same reference numerals will refer to the same or like parts.

In the following description of the present invention, detailed descriptions of known functions and components incorporated herein will be omitted when it may make the subject matter of the present invention unclear.

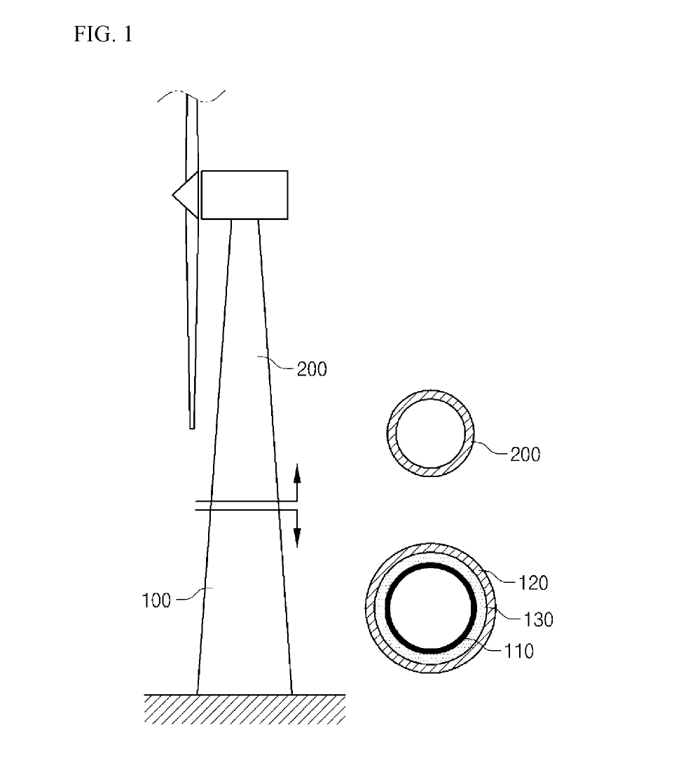

As shown in FIG. 1, a hybrid wind power tower having a steel tower and a DSCT tower combined according to a first embodiment of the present invention includes: a double-skinned composite tubular (DSCT) structure part 100 having an inner steel tube 110 and an outer steel tube 120 that concentrically stand on a foundation, the space between the inner steel tube and the outer steel tube being filled with concrete 130; and a steel structure part 200 provided on the DSCT structure part 100.

As mentioned above, the DSCT structure part 100 has the space between inner steel tube 110 and the outer steel tube 120 filled with the concrete 130. The hybrid wind power tower of the present invention includes a plastic hinge as the DSCT structure part 100.

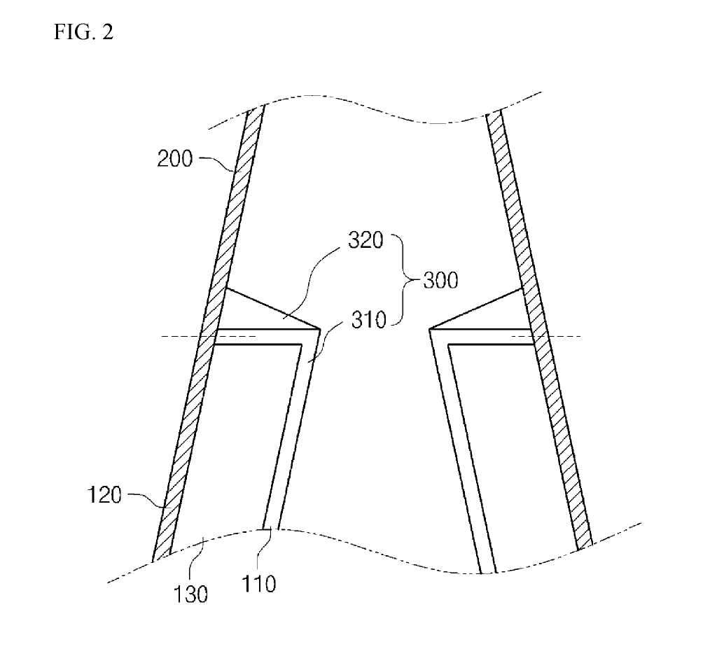

According to embodiments of the hybrid wind power tower of the present invention, as shown in FIG. 2, 3, or 5, the steel structure part 200 may extend from the inner steel tube 110 or the outer steel tube 120.

In this case, an upper surface of the concrete 130 is leveled so as to be perpendicular to a central axis of a longitudinal direction of the DSCT structure part 100. A combination-maintaining member 300 is provided on the upper surface of the concrete 130, the combination-maintaining member increasing a force of combining the steel structure part 200 with the DSCT structure part 100.

The combination-maintaining member 300 includes: a disc-shaped steel plate 310 fixed on the upper surface of the concrete 130; and a reinforcing member 320 protruding along a width direction of the steel plate 310 so as to be combined with the steel structure part 200. The reinforcing member 320 includes a plurality of reinforcing members provided on the steel plate 310 at predetermined intervals.

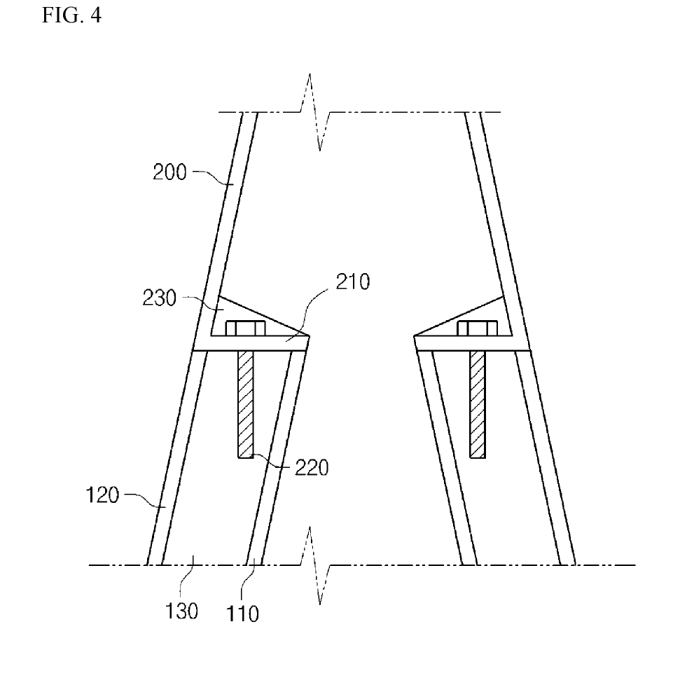

According to other embodiments of the hybrid wind power tower of the present invention, as shown in FIG. 4, 6, 7, 8, or 9, the upper surface of the concrete 130 is leveled so as to be perpendicular to the central axis of the longitudinal direction of the DSCT structure part 100, and a disc plate 210 may be provided to a lower end part of the steel structure part 200 such that the disc plate 210 sits on the upper surface of the concrete 130.

In this case, the disc plate 210 sitting on the upper surface of the concrete 130 is welded to the inner steel tube 110 and the outer steel tube 120. Additionally, a plurality of bolts 220 passing through the disc plate 210 are fastened to the concrete 130.

The plurality of reinforcing members 320 are provided by protruding from an upper surface of the disc plate 210 such that one surface of each of the reinforcing members is combined with the steel structure part 200.

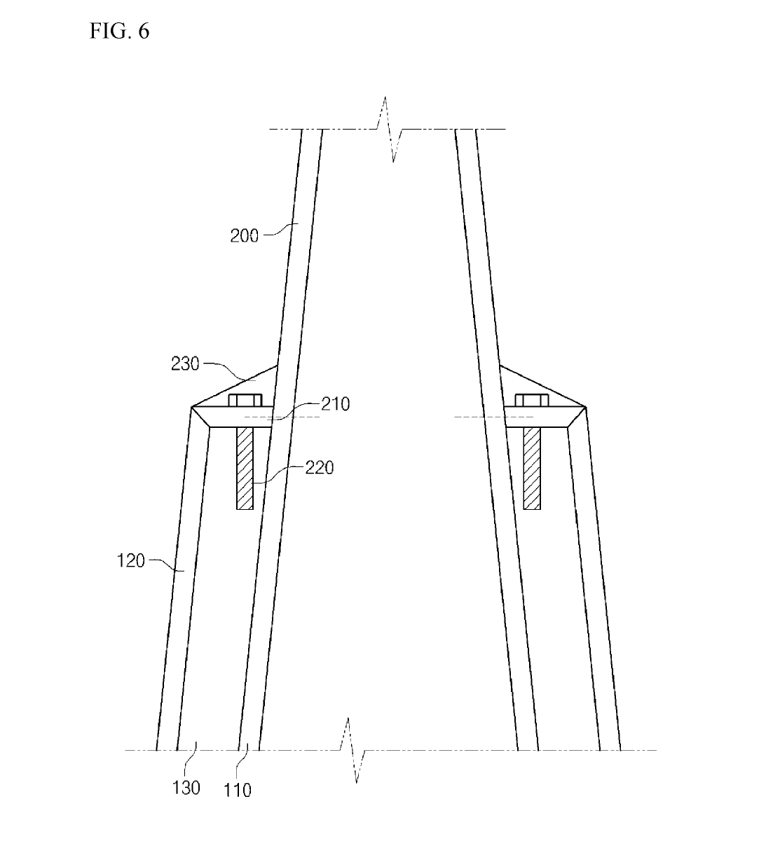

As shown in FIG. 4 or 6, an inner diameter or an outer diameter of the disc plate 210 may be configured to be the same as a diameter of the lower end part of the steel structure part 200.

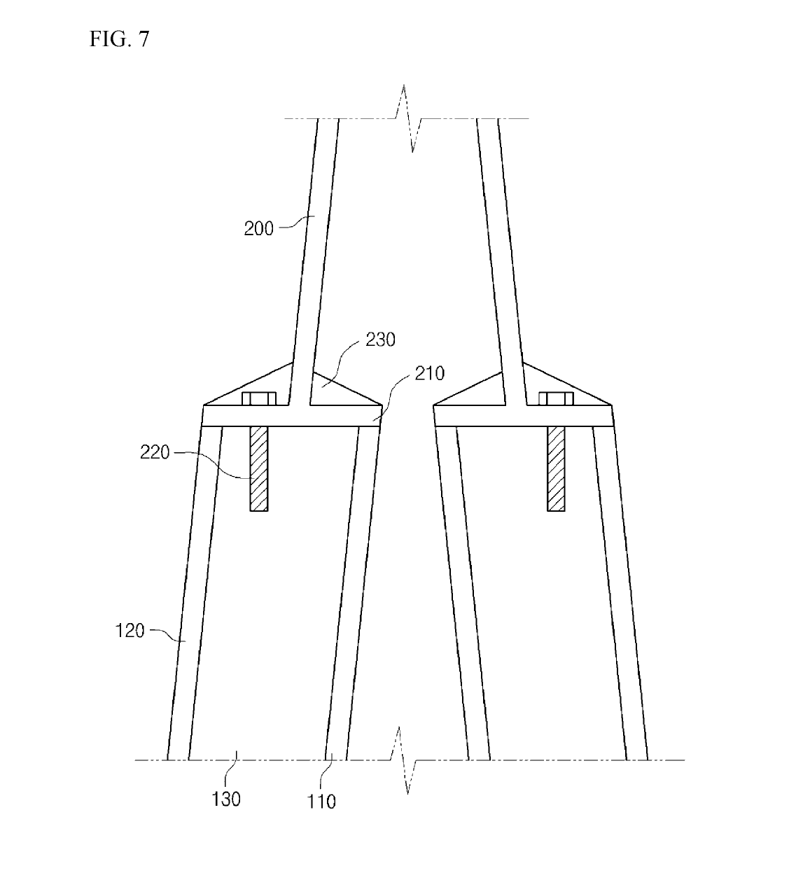

In addition, as shown in FIG. 7, 8, or 9, the inner diameter of the disc plate 210 may be configured to be smaller than the diameter of the lower end part of the steel structure part 200, and the outer diameter of the disc plate 210 may be configured to be larger than the diameter of the lower end part of the steel structure part 200.

In this case, a plurality of through holes are provided in an inner sector or an outer sector of the disc plate 210 that is divided based on the lower end part of the steel structure part 200, the bolts 220 being fastened to the concrete 130 after passing through the plurality of through holes.

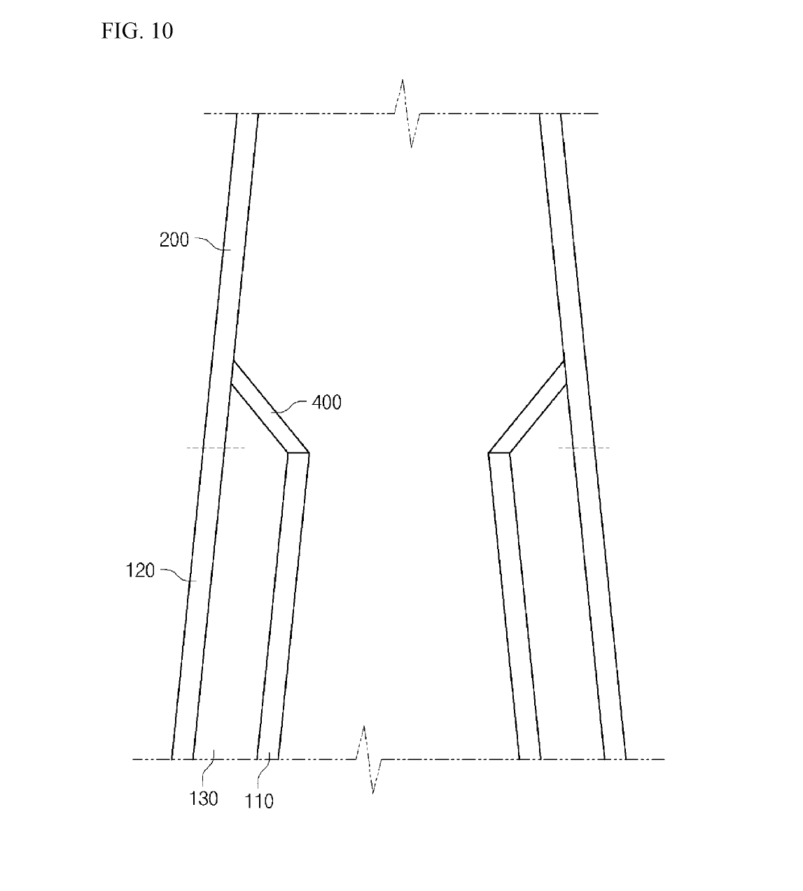

According to an eighth embodiment of the hybrid wind power tower of the present invention, as shown in FIG. 10, the steel structure part 200 may extend from the outer steel tube 120, and an inner expansion tube 400 may be provided on an end part of the inner steel tube 110, a diameter of the inner expansion tube increasing in an upward direction such that the inner expansion tube 400 comes into contact with the steel structure part 200.

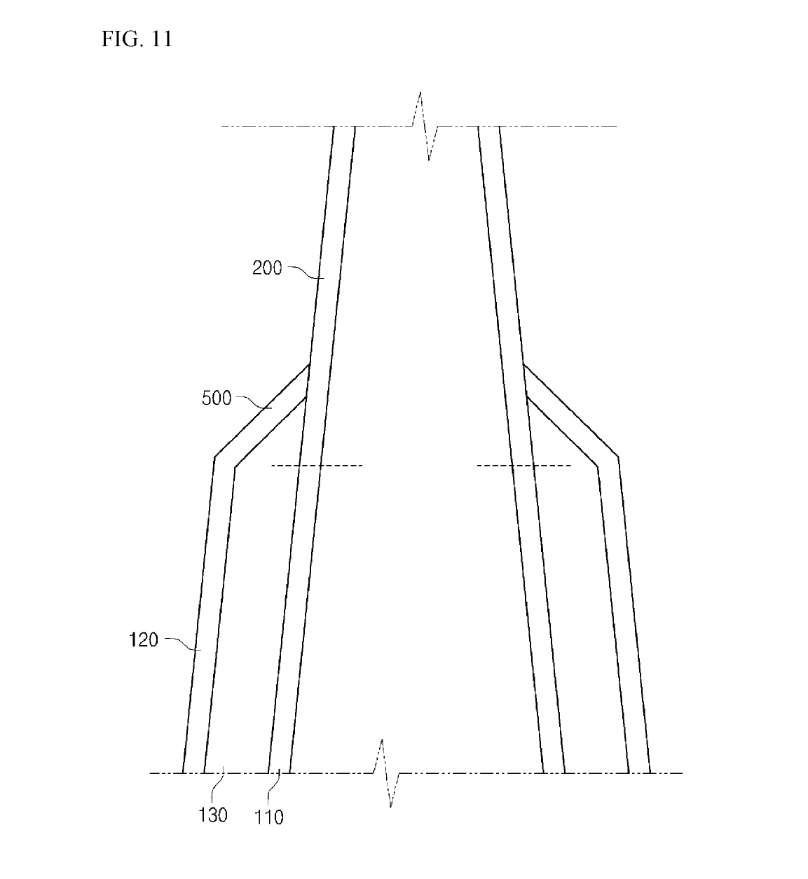

In addition, as shown in FIG. 11, the steel structure part 200 may extend from the inner steel tube 110, and an outer expansion tube 500 may be provided on an end part of the outer steel tube 120, a diameter of the outer expansion tube decreasing in an upward direction such that the outer expansion tube 500 comes into contact with the steel structure part 200.

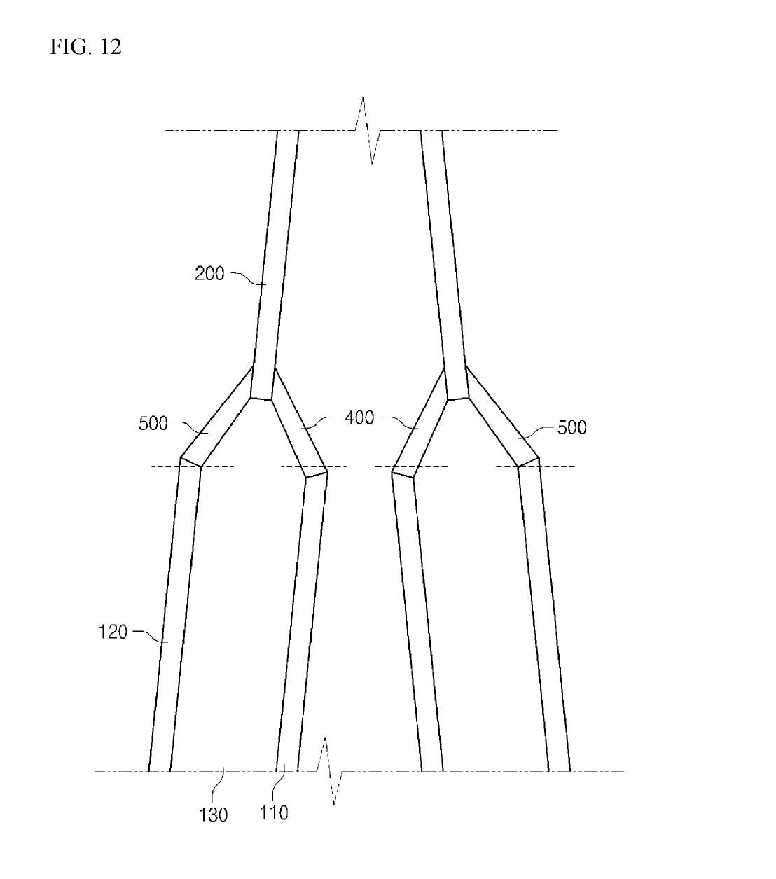

As shown in FIG. 12, the inner expansion tube 400 and the outer expansion tube 500 may be provided on end parts of the inner steel tube 110 and the outer steel tube 120 respectively at the same time, and the steel structure part 200 may be provided by extending upward from a contact part of the inner expansion tube 400 and the outer expansion tube 500.

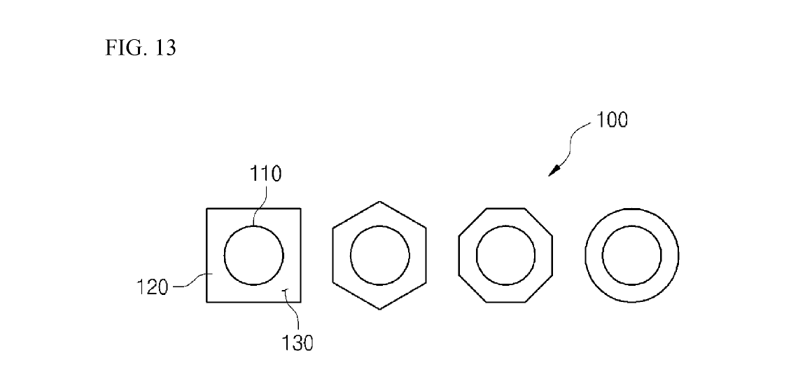

As shown in FIG. 13, the inner steel tube 110 may have a circular cross-section in a width direction thereof, and the outer steel tube 120 may have a polygonal cross-section such as a rectangular, a hexagonal or an octagonal cross-section, or have a circular cross-section in a width direction thereof.

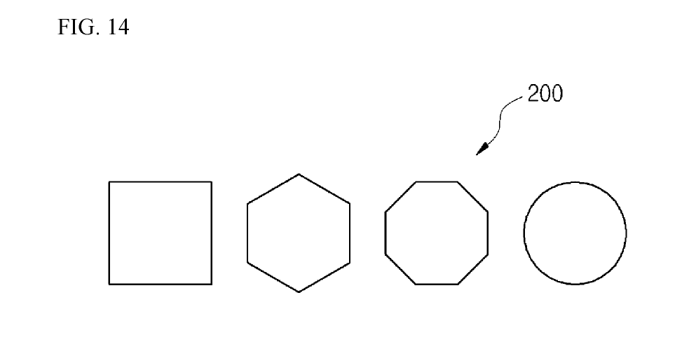

As shown in FIG. 14, the steel structure part 200 may have a polygonal cross-section such as a rectangular, a hexagonal or an octagonal cross-section, or have a circular cross-section in a width direction thereof.

According to the first embodiment of the present invention having the above-mentioned configuration, the hybrid wind power tower having a steel tower and a DSCT tower combined is provided with the plastic hinge having the DSCT structure near the foundation, thereby increasing structural safety. Particularly, compared to a prior art steel tower, the hybrid wind power tower is very high in buckling stability, which allows a plastic hinge of smaller diameter to be utilized.

In addition, a steel structure that has been used in manufacturing a prior art wind power tower sits on the plastic hinge, which realizes a desired height of a wind power tower and minimizes the total expense spent in manufacturing the wind power tower.

As mentioned above, preferred embodiments of the hybrid wind power tower having the steel tower and the DSCT tower combined according to the present invention have been described with reference to the accompanying drawings for illustrative purposes, and should not be construed as being restrictive. Those who are ordinarily skilled in the art will appreciate that various alternatives, modifications, and equivalents are possible, without changing the spirit or essential features of the present invention.

1. A hybrid wind power tower comprising:
a double-skinned composite tubular (DSCT) structure part having an inner steel tube and an outer steel tube that concentrically stand on a foundation, wherein a space between the inner steel tube and the outer steel tube is filled with concrete; and
a steel structure part having a single tube provided on the DSCT structure part.

2. The tower of claim 1, wherein the steel structure part extends from the inner steel tube or the outer steel tube,
an upper surface of the concrete is leveled so as to be perpendicular to a central axis of a longitudinal direction of the DSCT structure part, and
a combination-maintaining member is provided on the upper surface of the concrete, the combination-maintaining member increasing a force of combining the steel structure part with the DSCT structure part.

3. The tower of claim 2, wherein the combination-maintaining member includes:
a disc-shaped steel plate fixed on the upper surface of the concrete; and
a reinforcing member protruding along a width direction of the steel plate so as to be combined with the steel structure part,
wherein the reinforcing member comprises a plurality of reinforcing members provided on the steel plate at predetermined intervals.

4. The tower of claim 1, wherein an upper surface of the concrete is leveled so as to be perpendicular to a central axis of a longitudinal direction of the DSCT structure part,
a disc plate is provided to a lower end part of the steel structure part such that the disc plate sits on the upper surface of the concrete, wherein the disc plate sitting on the upper surface of the concrete is welded to the inner steel tube and the outer steel tube, and
a plurality of bolts passing through the disc plate are fastened to the concrete.

5. The tower of claim 4, wherein an inner diameter or an outer diameter of the disc plate is the same as a diameter of the lower end part of the steel structure part, or
the inner diameter of the disc plate is smaller than the diameter of the lower end part of the steel structure part, and the outer diameter of the disc plate is larger than the diameter of the lower end part of the steel structure part.

6. The tower of claim 4, wherein a plurality of reinforcing members are provided by protruding from an upper surface of the disc plate such that one surface of each of the reinforcing members is combined with the steel structure part.

7. The tower of claim 4, wherein an inner diameter of the disc plate is smaller than a diameter of the lower end part of the steel structure part, and an outer diameter of the disc plate is larger than the diameter of the lower end part of the steel structure part, and
a plurality of through holes are provided in an inner sector or an outer sector of the disc plate that is divided based on the lower end part of the steel structure part, the bolts being fastened to the concrete after passing through the plurality of through holes.

8. The tower of claim 1, wherein the steel structure part extends from the inner steel tube, and
an outer expansion tube is provided on an end part of the outer steel tube, a diameter of the outer expansion tube decreasing in an upward direction such that the outer expansion tube comes into contact with the steel structure part.

9. The tower of claim 1, wherein the steel structure part extends from the outer steel tube, and
an inner expansion tube is provided on an end part of the inner steel tube, a diameter of the inner expansion tube increasing in an upward direction such that the inner expansion tube comes into contact with the steel structure part.

10. The tower of claim 1, wherein an inner expansion tube is provided on an end part of the inner steel tube, a diameter of the inner expansion tube increasing in an upward direction,
an outer expansion tube is provided on an end part of the outer steel tube, a diameter of the outer expansion tube decreasing in an upward direction, and
a lower end part of the steel structure part is combined with end parts of the inner expansion tube and the outer expansion tube, the inner expansion tube and the outer expansion tube being in contact with each other at the end parts thereof.

11. The tower of claim 1, wherein the inner steel tube has a circular cross-section in a width direction thereof,
the outer steel tube has a polygonal cross-section such as a rectangular, a hexagonal or an octagonal cross-section, or has a circular cross-section in a width direction thereof, and
the steel structure part has a polygonal cross-section such as a rectangular, a hexagonal or an octagonal cross-section, or has a circular cross-section in a width direction thereof.
